(19) United States
(12) Patent Application Publication
(10) Pub. No.: US 2025/0042274 A1
(43) Pub. Date: Feb. 6, 2025

(54) Charging Management For Electric Work Vehicles

(71) Applicant: Caterpillar Inc., Peoria, IL (US)

(72) Inventors: Matthew J. HARRENSTEIN, Raleigh, NC (US); Thomas L. TWIGGER, Spalding (GB)

(73) Assignee: Caterpillar Inc., Peoria, IL (US)

(21) Appl. No.: 18/716,050

(22) PCT Filed: Nov. 23, 2022
(86) PCT No.: PCT/US2022/050837

§ 371 Date: Jun. 3, 2024

(30) Foreign Application Priority Data
Dec. 3, 2021 (GB) 2117521.1

(51) Int. Cl. B60L 53/16; B60L 53/62; B60L 53/66; B60L 53/80; B60L 58/12; B60L 58/16; H01R 13/639

(52) U.S. Cl. CPC B60L 53/16; B60L 53/62; B60L 53/66; B60L 53/80; B60L 58/12; B60L 58/16; H01R 13/639; B60L 2200/40

(57) ABSTRACT

A mobile electric power supply unit for supplying power to an electric work vehicle comprises a battery. The power supply unit comprises a power supply coupler configured to couple to a transporter vehicle, wherein the power supply unit is configured to be transported by the transporter vehicle when the power supply coupler is coupled to the transporter vehicle.

### FIELD OF THE DISCLOSURE

The disclosure relates to the field of electric work vehicles.

### BACKGROUND

Large worksites can pose challenges for efficiently managing charging of electric work vehicles. The electric work vehicles may operate at long distances from charging units, and an electric work vehicle may risk becoming stranded if the state of charge of its battery is insufficient to reach the charging unit.

This issue may be exacerbated as large worksites having more than one charging point for electric work vehicles, for example at different locations. An operator of an electric work vehicle may not know the location of the charging points, particularly if the charging point locations vary between worksites or if the charging points are mobile. The operator may waste time and charge when travelling to look for a charging point.

An operator of an electric work vehicle may travel to a charging point in order to charge without knowledge of any properties of the charging point, and so risk not being able to charge. For example, the charging point may be in use by another vehicle, low on charge, out of order, the wrong type of charging point, or otherwise unusable. In the event that an electric work vehicle cannot charge at the charging point, the electric work vehicle may be required to wait or to travel to a different charging point.

### SUMMARY OF THE DISCLOSURE

A mobile electric power supply unit is provided for charging an electric work vehicle comprising a battery. The power supply unit comprises a power supply coupler configured to couple to a transporter vehicle, wherein the power supply unit is configured to be transported by the transporter vehicle when the power supply coupler is coupled to the transporter vehicle.

In this way, the power supply unit may be transported to different locations on a worksite to provide power to electric work vehicles. The power supply unit may comprise a charger or a replacement battery, so that an electric work vehicle can be charged by the power supply unit, or receive a replacement battery. For example, the power supply unit may be transported to a location that is easily accessible by electric work vehicles. The power supply unit may be transported to a location that is closer to electric work vehicles that are likely to require power than the previous location of the power supply unit, or that is more central with respect to the electric work vehicles. As the electric work vehicles may move during the day, the power supply unit may be kept in a convenient location for providing power to the electric work vehicles by moving the power supply unit. The power supply unit may also be transported directly to an electric work vehicle that requires charging or a replacement battery. This may minimise loss of working time for the electric work vehicle. It may also allow charging of electric work vehicles that have insufficient charge to travel to a charging point. This may be useful if an electric work vehicle has accidentally or unexpectedly reached a low state of charge. Furthermore, the electric work vehicle may be used for longer if it is not necessary to save charge to travel to a charging point.

### BRIEF DESCRIPTION OF THE DRAWINGS

A specific embodiment of the disclosure will now be described, by way of example only, with reference to the accompanying drawings in which:

FIG. 1 shows a schematic block diagram of a mobile electric power supply unit coupled to a transporter unit in accordance with an embodiment of the present disclosure.

FIG. 2 shows a schematic diagram of an electric work vehicle communicating with a power supply unit according to an embodiment of the present disclosure.

FIG. 3 shows a schematic diagram of a power supply coupler and a vehicle coupler according to an embodiment of the present disclosure.

FIG. 4 shows a schematic diagram of a power supply coupler and a vehicle coupler according to an embodiment of the present disclosure.

FIG. 5 a schematic diagram of a transporter vehicle and a power supply coupler according to an embodiment of the present disclosure.

FIG. 6 shows a schematic diagram of an electric work vehicle communicating with a power supply unit via a central controller according to an embodiment of the present disclosure.

### DETAILED DESCRIPTION

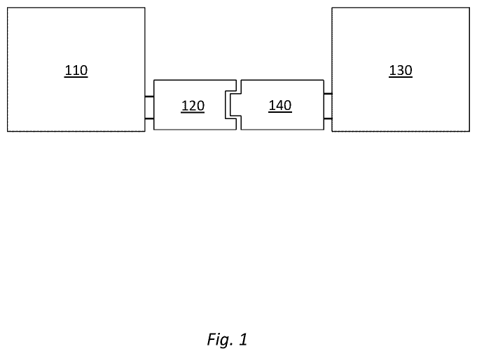

With reference to FIG. 1, a mobile electric power supply unit 110 is provided, the mobile electric power supply unit 110 having integrated coupler functionality. The power supply unit 110 comprises a power supply coupler 120 configured to couple to a transporter vehicle 130 via a vehicle coupler 140.

The power supply unit 110 is configured to provide power to electric work vehicles. The power supply unit 110 may comprise a charger that is configured to charge a battery of the electric work vehicle. The power supply unit 110 may comprise a replacement battery for the electric work vehicle.

The transporter vehicle 130 is configured to move the power supply unit 110 around a worksite.

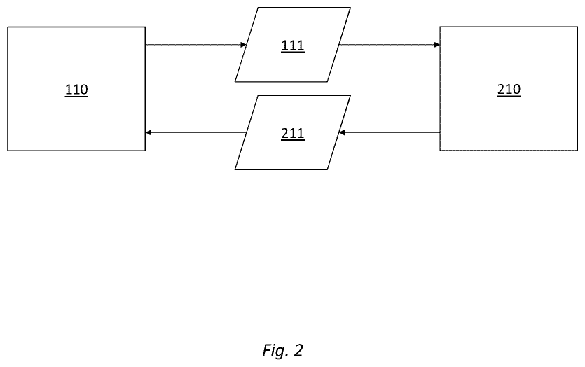

With reference to FIG. 2, the power supply unit 110 may be configured to supply power supply properties 111 from the power supply unit 110 to an electric work vehicle 210 and to receive vehicle properties 211 from the electric work vehicle 210. A power decision is made based on power information, wherein the power information is based on the power supply properties 111 and the vehicle properties 211.

In an event that the power decision comprises a decision that the electric work vehicle 210 requires power, the electric work vehicle 210 and the power supply unit 110 are brought together. The power supply properties may comprise a location of the power supply unit 110. The vehicle properties 211 comprise a current state of charge of a battery of the electric work vehicle 210 and a capacity of the battery of the electric work vehicle 210.

In an embodiment the power supply unit 110 comprises a charger. The power supply properties 111 may comprise charger properties. The power decision may comprise a charging decision is made based on power information.

In an event that the power decision comprises a decision to charge the electric work vehicle 210, the electric work vehicle 210 and the power supply unit 110 are brought together. The power supply properties 111 may comprise a location of the power supply unit 110 and an availability of the power supply unit 110. The vehicle properties 211 comprise a current state of charge of a battery of the electric work vehicle 210 and a capacity of the battery of the electric work vehicle 210.

In another embodiment, the power supply unit 110 comprises a replacement battery. In an event that the power decision comprises a decision to replace a vehicle battery of the electric work vehicle, the electric work vehicle 210 and the power supply unit 110 are brought together. The vehicle battery of the electric work vehicle may be replaced with the replacement battery, and the power supply unit 110 may be configured to receive the vehicle battery that has been removed from the electric work vehicle. The power supply properties 111 may comprise a location of the power supply unit 110 and an availability of the power supply unit 110. The vehicle properties 211 comprise a current state of charge of a battery of the electric work vehicle 210 and a capacity of the battery of the electric work vehicle 210.

The power supply properties may further comprise at least one of a voltage of the replacement battery and a battery type of the replacement battery.

Bringing the electric work vehicle 210 and the power supply unit 110 together may further comprise a decision between moving the electric work vehicle 210 to the power supply unit 110 and moving the power supply unit 110 to the electric work vehicle 210. For example, this decision may be based on the state of charge of the battery of the electric work vehicle 210. The decision may be based on the distance of the power supply unit 110 from other electric work vehicles that require power, or that may require power soon. The decision may be based on the urgency of the work currently being carried out by the electric work vehicle 210.

The power supply unit 110 is configured to be moved by a transporter vehicle 130. The transporter vehicle 130 comprises a vehicle coupler 140 configured to attach to and detach from the charging coupler 120 of the power supply unit 110. In an embodiment, the transporter vehicle 130 may comprise a skid steer, a compact wheel loader, a wheeled material handler, a tracked material handler, or any other suitable machine.

In an embodiment, one of the power supply coupler 120 and the vehicle coupler 140 may comprise a coupler with vertical locking pins (such as a universal skid-steer coupler). In another embodiment, one of the power supply coupler 120 and the vehicle coupler 140 may comprise a coupler with horizontal locking pins (such as a “hook on” coupler for compact loaders). The power supply coupler 120 and the vehicle coupler 140 may comprise other types of coupler, such as one with vertical locking wedges or coupling mechanism. The power supply coupler 120 or the vehicle coupler 140 may comprise a quick coupler bracket. The power supply coupler 120 may be on the side, top or bottom of the power supply unit 110, wherein the power supply coupler 120 is configured to couple to the vehicle coupler 140.

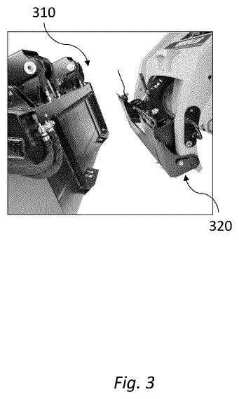

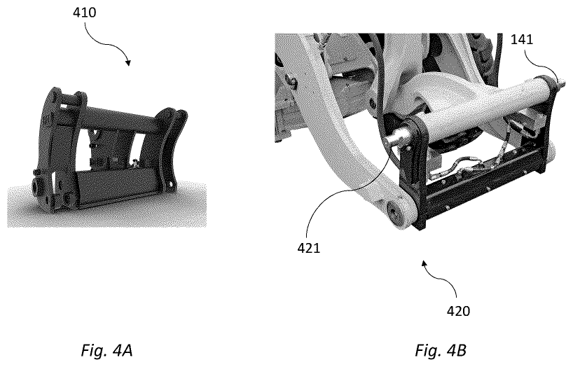

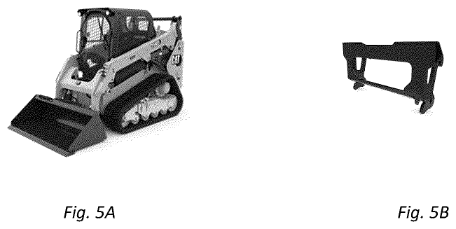

With reference to FIG. 3, an example of a pair of couplers 310 and 320 is shown. Coupler 320 comprises vertical locking pins. One of the power supply coupler 120 and the vehicle coupler 140 may comprise coupler 310, and the other of the power supply coupler 120 and the vehicle coupler 140 may comprise coupler 320. With reference to FIG. 4, another example of a pair of couplers 410 (FIG. 4A) and 420 (FIG. 4B) is shown. Coupler 420 comprises horizontal locking pins 421. One of the power supply coupler 120 and the vehicle coupler 140 may comprise coupler 410, and the other of the power supply coupler 120 and the vehicle coupler 140 may comprise coupler 420. FIG. 5 shows a skid steer vehicle (FIG. 5A) as an example of a transporter vehicle 130, and a skid steer coupler (FIG. 5B) as an example of a power supply coupler 120 or a vehicle coupler 140.

The transporter vehicle may be configured to communicate with the work vehicle and with the power supply unit 110. The transporter vehicle may comprise a telematics module.

In an embodiment, the transporter vehicle 130 may be autonomous. In another embodiment, the transporter vehicle 130 may be operated by an operator. In an embodiment, the electric work vehicle 210 may be operated by an operator. In another embodiment, the electric work vehicle 210 may be autonomous.

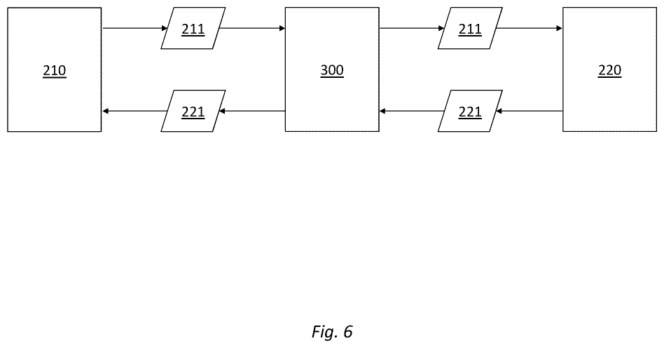

Communicating power supply properties 111 to the electric work vehicle 210 and communicating vehicle properties 211 to the power supply unit 110 may occur at the same time, or sequentially in either order. The power supply properties 111 and vehicle properties 211 may be communicated continuously or at regular intervals. The power supply properties 111 and vehicle properties 211 may alternatively be communicated on demand, for example in response to a request by an operator. The power supply properties 111 and vehicle properties 211 may be communicated directly between the power supply unit 110 and the electric work vehicle 210. With reference to FIG. 6, the power supply properties 111 and vehicle properties 211 may be communicated between the power supply unit 110 and the electric work vehicle 10 via a central controller 300.

The power supply unit 110 and the electric work vehicle 210 may each comprise a telematics module. The telematics modules may be configured to send and receive the charger properties 111 and the vehicle properties 211.

In an embodiment where the power supply unit 110 comprises a charger, the power supply unit 110 may not be connected to the mains supply. The power supply unit 110 may comprise a power pack. The power supply unit 110 may comprise a generator.

In an embodiment where the power supply unit 110 comprises a charger, the power supply properties 111 may further comprise a health status of the power supply unit 110. For example, whether the power supply unit 110 is working, and whether there is any damage to the power supply unit 110 or limited capability of the power supply unit 110. The power supply properties 111 may further comprise a charging capacity of the power supply unit 110. The charging capacity may comprise a state of charge of a power pack. In an embodiment, the charging capacity may comprise either an indication that the power supply unit 110 has sufficient charge to fully charge the battery, or an indication of the predicted state of charge of the battery after fully draining the power supply unit 110. The power supply properties 111 may further comprise a charging rate of the power supply unit 110, and a charger connection type (such as DC, AC, three phase).

In an embodiment where the power supply unit 110 comprises a charger, the power supply properties 111 may comprise an availability of the power supply unit 110. The availability of the power supply unit 110 may comprise an indication of whether the power supply unit 110 is in use and a reservation status of the power supply unit 110. For example, the power supply unit 110 may be currently in use, currently free, reserved for use at a certain time by another vehicle, or unreserved. In an event that the power supply unit 110 is in use, the availability of the power supply unit 110 may further comprise a predicted charging end time at which the power supply unit 110 will be available. Similarly, in an event that the power supply unit 110 is reserved, the availability of the power supply unit 110 may further comprise a period when the power supply unit 110 is free prior to the reservation and/or a predicted end time of the reservation.

The predicted charging end time may be communicated from the power supply unit 110 to the electric work vehicle 210. The predicted charging end time may be calculated by the electric work vehicle 210 or central controller 300 based on a current state of charge of the battery being charged, a target state of charge of the battery being charged, and a charging rate of the power supply unit 110. In an event that the power supply unit 110 is not connected to the mains supply, the charger properties 111 may further comprise a predicted state of charge of the power supply unit 110 at the predicted charging end time.

In an embodiment, the power supply unit 110 may comprise a DC charger and the charger properties 111 may further comprise a DC voltage of the charger.

In an embodiment where the power supply unit 110 comprises a replacement battery, the power supply properties may comprise an availability of the replacement battery. For example, whether the replacement battery is being transported to a different electric work vehicle or whether it is available.

The vehicle properties 211 may further comprise a predicted time before power (via either charging or a replacement battery) is required. The predicted time may be based on at least one of a current state of charge, a discharge rate, and a distance from the power supply unit 110. The discharge rate may be based on a current discharge rate. The discharge rate may be based on data from previous discharging of the battery, for example data comprising discharge rates at different states of charge, or discharge rates for the operator, or discharge rates for performing various tasks with the electric work vehicle 210. The distance of the electric work vehicle 210 from the power supply unit 110 may be used to calculate the state of charge required to travel to the power supply unit 110, and therefore the minimum state of charge that the electric work vehicle 210 can reach before needing to travel to the power supply unit 110. This may be a factor in the decision as to whether to move the electric work vehicle 210 to the power supply unit 110 or to move the power supply unit 110 to the electric work vehicle 210.

The power decision may further comprise a decision as to whether to charge the electric work vehicle 210 or to replace the battery of the electric work vehicle 210. This may be based on one or more of the current state of charge of the electric work vehicle 210, the location of a power supply unit 110 comprising a charger, the location of a power supply unit 110 comprising a replacement battery, the location of the electric work vehicle 210 and the health of the battery of the electric work vehicle 210.

The vehicle properties may further comprise an available time period for charging. The available time may be based on a return-to-work time for the electric work vehicle 210. For example, the electric work vehicle 210 may be charged at the end of an operator's shift, and the return-to-work time may comprise the beginning of the next shift for the electric work vehicle 210 (for the same or a different operator). Otherwise, an available time period may comprise a lunch break of the operator, a weekend, a closed period of the worksite, or other time period.

The vehicle properties 211 may further comprise a target state of charge for charging. For example, the target state of charge may be to fully charge the battery to a 100% state of charge. The target state of charge may comprise a state of charge that has been determined to be appropriate to maintain good battery health. The target state of charge may be the state of charge required to complete the next task or the next shift.

The vehicle properties 211 may further comprise at least one of a battery voltage, a maximum charge rate of the battery, a state of health of the battery, and a temperature of the battery.

The power supply unit 110 may comprise a geofence. The geofence may define a perimeter around the power supply unit 110, for example based on a radius from the power supply unit 110. Within the geofence, a speed of the electric work vehicle 210 may be limited to below a threshold speed, and/or the electric work vehicle 210 may be limited in the tasks it can perform. There may be other limitations, such as the number of work vehicles permitted to be within the geofence at any one time The power supply properties 111 may further comprise the geofence and any limitations on the electric work vehicle 210 that occur within the geofence. The geofence may also prevent the transporter vehicle 130 from entering a geofenced area, or prevent the power supply unit 110 on the transporter vehicle 130 from charging an electric work vehicle in a geofenced area.

In an embodiment, the power information provided to an operator of the electric work vehicle 210 may comprise information to allow the operator to make an informed power decision. For example, the power information may comprise the predicted time before power is required and distances to available power supply units 110. In another embodiment, the power information provided to the operator may comprise a result of a power decision made by a controller (for example, either the central controller 300 or a controller of the work vehicle). For example, the controller may decide whether the electric work vehicle 210 should travel to a power supply unit 110 (and if so which power supply unit 110 the electric work vehicle 210 should travel to, and when the electric work vehicle 210 should travel to or arrive at the power supply unit 110) or whether the electric work vehicle 210 should wait for a power supply unit 110 to travel to the electric work vehicle 210.

The method may further comprise making a reservation of the power supply unit 110. The reservation may be made by the operator based on the power information. The reservation may be suggested to the operator by a controller based on a power decision made by the controller, and the operator may confirm or reject the reservation. The reservation may be made by a controller based on a power decision made by the controller, without input from the operator.

A plurality of power supply units 110 may be configured to communicate power supply properties 111 to an electric work vehicle 210. The power information may be based on the power supply properties 111 for the plurality of power supply units 110, such that the power decision (made by the operator or a controller) comprises a decision of whether or when to charge the electric work vehicle 210 or replace the battery of the electric work vehicle 210, and which power supply unit 110 to use.

The power supply unit 110 may be configured to receive vehicle properties 211 from a plurality of electric work vehicles 210.

The power information may be provided to the operator via a display in the vehicle cab, via a smartphone, or by other means.

According to an embodiment, a method of power supply management for electric work vehicles is provided. Power supply properties 111 are communicated from a power supply unit 110 to an electric work vehicle 210. Vehicle properties 211 are communicated from the electric work vehicle 210 to the power supply unit 110. A power decision is made based on power information, wherein the power information is based on the power supply properties 111 and the vehicle properties 211.

The power supply unit 110 comprises a mobile electric power supply unit 110 having integrated coupler functionality. The power supply unit 110 comprises a power supply coupler 120 configured to couple to a transporter vehicle 130 via a vehicle coupler 140. The power supply unit 110 is configured to provide power to electric work vehicles. The transporter vehicle 130 is configured to move the power supply unit 110 around a worksite.

In an event that the power decision comprises a decision to supply power to the electric work vehicle 210, the electric work vehicle 210 and the power supply unit 110 are brought together. The power supply properties 111 comprise a location of the power supply unit 110. The vehicle properties 211 comprise a current state of charge of a battery of the electric work vehicle 210 and a capacity of the battery of the electric work vehicle 210.

1. A mobile electric power supply unit for supplying power to an electric work vehicle comprising a battery, the power supply unit comprising a power supply coupler configured to couple to a transporter vehicle, wherein:
the power supply unit is configured to be transported by the transporter vehicle when the power supply coupler is coupled to the transporter vehicle;
the power supply unit is configured to supply power supply properties from the power supply unit to the electric work vehicle and to receive vehicle properties from the electric work vehicle; and
a power decision is made based on power information, wherein the power information is based on the power supply properties and the vehicle properties, wherein the power supply properties comprise a charging capacity of the power supply unit and wherein the vehicle properties comprise an available time period for charging.

2. The mobile electric power supply unit of claim 1 wherein the power supply unit comprises a charger for charging the electric work vehicle.

3. The mobile electric power supply unit of claim 1 wherein the power supply unit comprises a replacement battery for the electric work vehicle.

4. The mobile electric power supply unit of claim 1 wherein the power supply coupler is configured to couple to a vehicle coupler of the transporter vehicle.

5. The mobile electric power supply unit of claim 4 wherein at least one of the power supply coupler and the vehicle coupler comprises vertical locking pins or vertical locking wedges.

6. The mobile electric power supply unit of claim 4 wherein at least one of the power supply coupler and the vehicle coupler comprises horizontal locking pins or horizontal locking wedges.

7. The mobile electric power supply unit of claim 4 wherein the vehicle coupler comprises a universal skid-steer coupler.

8. The mobile electric power supply unit of claim 1 wherein the transporter vehicle comprises one of a wheeled material handler, a tracked material handler, or a skid steer.

9. The mobile electric power supply unit of claim 1 wherein the power supply unit is configured to communicate with the transporter vehicle.

10. The mobile electric power supply unit of claim 1 wherein the transporter vehicle is autonomous.

11. The mobile electric power supply unit of claim 2 wherein a controller is configured to:
communicate power supply properties from the power supply unit to an electric work vehicle;
communicate vehicle properties from the electric work vehicle to the power supply unit; and
make a power decision based on power information, wherein the power information is based on the power supply properties and the vehicle properties;
wherein in an event that the power decision comprises a decision to supply power to the vehicle, the electric work vehicle and the power supply unit are brought together;
wherein the power properties comprise a location of the power supply unit; and
wherein the vehicle properties comprise:
a current state of charge of the battery of the electric work vehicle; and
a capacity of the battery.

12. The mobile electric power supply unit of claim 11 wherein the step of bringing the electric work vehicle and the power supply unit together further comprises a decision between:
moving the electric work vehicle to the power supply unit; and
moving the power supply unit to the electric work vehicle using the transporter vehicle.

13. The mobile electric power supply unit of claim 11 wherein the transporter vehicle is configured to communicate with the electric work vehicle and with the power supply unit.

14. The mobile electric power supply unit of claim 11 wherein the power supply unit comprises a charger and wherein the power supply properties further comprise one or more of:
a health status of the power supply unit;
a charging capacity of the power supply unit;
a charging rate;
a charger connection type; and
an availability of the power supply unit comprising at least one of:
an indication of whether the power supply unit is in use; and
a reservation status of the power supply unit.

15. The mobile electric power supply unit of claim 11, wherein the vehicle properties further comprise at least one of:
a predicted time before power is required;
an available time period for charging;
a target state of charge for charging;
a battery voltage;
a maximum charge rate of the battery;
a state of health of the battery; and
a temperature of the battery.
